(19) United States
(12) Patent Application Publication
(10) Pub. No.: US 2018/0283784 A1
(43) Pub. Date: Oct. 4, 2018

(54) METHOD FOR MANUFACTURING HONEYCOMB STRUCTURE

(71) Applicant: NGK Insulators, Ltd., Nagoya-City (JP)

(72) Inventor: Kensuke Okumura, Nagoya-City (JP)

(73) Assignee: NGK Insulators, Ltd., Nagoya-City (JP)

(21) Appl. No.: 15/921,885

(22) Filed: Mar. 15, 2018

(30) Foreign Application Priority Data
Mar. 28, 2017 (JP) 2017-063621

(51) Int. Cl. F26B 3/347; B28B 11/24; C04B 33/30

(52) U.S. Cl. CPC F26B 3/347; B28B 11/243; B28B 11/247; C04B 38/0006; C04B 2235/606; F26B 2210/02; C04B 33/30

(57) ABSTRACT

A method for manufacturing a honeycomb structure, includes: a step of manufacturing a honeycomb formed body to manufacture a non-fired honeycomb formed body, the non-fired honeycomb formed body including a raw material composition containing a ceramic raw material and water; an induction drying step of drying the manufactured non-fired honeycomb formed body by induction drying to obtain a honeycomb dried body; and a firing step of firing the obtained honeycomb dried body to obtain a honeycomb structure. The induction drying step is to remove 10 to 50% of the entire water that the non-fired honeycomb formed body contained before drying by induction drying to obtain a first dried honeycomb formed body, then turn the first dried honeycomb formed body upside down and remove the residual water by further induction drying to obtain the honeycomb dried body.

“The present application is an application based on JP-2017-063621 filed on Mar. 28, 2017 with Japan Patent Office, the entire contents of which are incorporated herein by reference.”

### BACKGROUND OF THE INVENTION

### Field of the Invention

The present invention relates to a method for manufacturing a honeycomb structure. More particularly the present invention relates to a method for manufacturing a honeycomb structure having short drying time of a honeycomb formed body and so capable of shortening the manufacturing time.

### Description of the Related Art

Conventionally honeycomb structures made of ceramics have been widely used as a catalyst carrier or a various types of filters. Such a honeycomb structure made of ceramics has been used for a diesel particulate filter (DPF) as well to capture particulate matters (PMs) emitted from a diesel engine.

To produce such a honeycomb structure, a kneaded material is typically extruded to make a honeycomb-shaped formed body (honeycomb formed body), and this honeycomb formed body is dried and then fired. The kneaded material is produced by adding water and various additives, such as binder, to a ceramic material to prepare a raw material and kneading the raw material.

The following methods are known to dry the honeycomb formed body. More specifically, the known drying methods include natural drying to simply allow a honeycomb formed body to stand at room temperatures, hot-air drying to introduce hot air generated by a gas burner for drying, induction drying, and microwave drying using microwaves. The induction drying method is to apply electric current between electrodes disposed above and below the honeycomb formed body so as to generate high-frequency energy there and dry the honeycomb formed body by the high-frequency energy. According to a reported technique for the induction drying method, defects in the cells of the honeycomb formed body during drying, such as cell deformation, can be avoided by covering the honeycomb formed body with a sheet during drying (see Patent Document 1).

[Patent Document 1] JP-A-2002-228359

### SUMMARY OF THE INVENTION

The method described in Patent Document 1 requires a step to prepare a sheet for covering the honeycomb formed body. Advantageously the method described in Patent Document 1 can delay the drying of the honeycomb formed body at the circumferential part so as to keep a substantially same drying speed between the outer part and the inner part of the honeycomb formed body for better balancing of the drying. Such a method, however, has a problem of requiring time to the drying and so to manufacture the honeycomb structure due to the required drying time. That is, this method has a problem of low productivity of honeycomb structures.

In view of such problems of the conventional techniques, the present invention provides a method for manufacturing a honeycomb structure having short drying time of a honeycomb formed body and so capable of shortening the manufacturing time.

[1] A method for manufacturing a honeycomb structure, including: a step of manufacturing a honeycomb formed body to manufacture a non-fired honeycomb formed body including a cell wall that defines a plurality of cells extending from a first end face as one end face to a second end face as the other end face, the non-fired honeycomb formed body including a raw material composition containing a ceramic raw material and water; an induction drying step of drying the manufactured non-fired honeycomb formed body by induction drying to obtain a honeycomb dried body; and a firing step of firing the obtained honeycomb dried body to obtain a honeycomb structure, wherein the induction drying step is to remove 10 to 50% of the entire water that the non-fired honeycomb formed body contained before drying by induction drying to obtain a first dried honeycomb formed body, then turn the first dried honeycomb formed body upside down and remove the residual water by further induction drying to obtain the honeycomb dried body.

[2] The method for manufacturing a honeycomb structure according to [1], wherein the non-fired honeycomb formed body to be supplied to the induction drying step has water content before drying of 20 to 50%.

[3] The method for manufacturing a honeycomb structure according to [1] or [2], further including a hot air drying step of further drying the honeycomb dried body subjected to the induction drying step by hot air.

[4] The method for manufacturing a honeycomb structure according to any one of [1] to [3], wherein the non-fired honeycomb formed body to be supplied to the induction drying step has a thickness of the cell wall that is 50 to 350 μm.

[5] The method for manufacturing a honeycomb structure according to any one of [1] to [4], wherein, in the induction drying step, drying is performed using a first induction drying device to obtain the first dried honeycomb formed body and a second induction drying device to further induction-dry the first dried honeycomb formed body to obtain the honeycomb dried body.

The method for manufacturing a honeycomb structure of the present invention has short drying time of a honeycomb formed body and so is capable of shortening the manufacturing time.

### BRIEF DESCRIPTION OF THE DRAWING

FIG. 1 schematically describes an induction drying step in one embodiment of a method for manufacturing a honeycomb structure of the present invention.

### DESCRIPTION OF THE PREFERRED EMBODIMENTS

The following specifically describes embodiments of the present invention, with reference to the drawing. The present invention is not limited to the following embodiments. The present invention is to be understood to include the following embodiments, to which modifications and improvements are added as needed based on the ordinary knowledge of a person skilled in the art without departing from the scope of the present invention.

(1) Method for Manufacturing a Honeycomb Structure:

One embodiment of a method for manufacturing the honeycomb structure of the present invention includes a step of manufacturing a honeycomb formed body, an induction drying step, and a firing step. A honeycomb structure can be manufactured through these steps. More specifically, the step of manufacturing a honeycomb formed body is to manufacture “a non-fired honeycomb formed body including a cell wall that defines a plurality of cells extending from a first end face as one end face to a second end face as the other end face”. This non-fired honeycomb formed body includes a raw material composition containing a ceramic raw material and water. The induction drying step is to dry the manufactured non-fired honeycomb formed body by induction drying so as to obtain a honeycomb dried body. This induction drying step has a first drying step to obtain “a first dried honeycomb formed body obtained by removing 10 to 50% of the entire water that the non-fired honeycomb formed body contained before drying” by induction drying. This induction drying step also has a step following the first drying step to turn the first dried honeycomb formed body upside down and then a second drying step to remove the residual water by additional induction drying to obtain a honeycomb dried body. The firing step is to fire the obtained honeycomb dried body to obtain a honeycomb structure.

The method for manufacturing a honeycomb structure of the present invention has short drying time of a honeycomb formed body and so is capable of shortening the manufacturing time of the honeycomb structure.

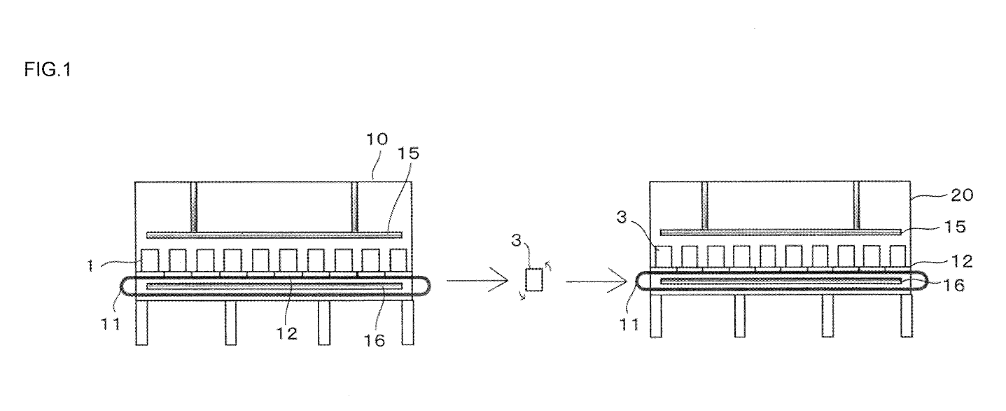

FIG. 1 schematically shows the induction drying step in the method for manufacturing a honeycomb structure of the present invention. As shown in FIG. 1, a non-fired honeycomb formed body 1 is placed on a perforated plate 12 disposed on a conveyor 11 of an induction drying device (first induction drying device) 10, and voltage is applied to electrode plates 15, 16 located above and below the non-fired honeycomb formed body 1. Then, the honeycomb formed body is dried using high-frequency energy. In this way, the non-fired honeycomb formed body 1 is induction-dried under the predetermined condition as stated above to obtain a first dried honeycomb formed body 3 (first drying step). Thereafter, the first dried honeycomb formed body 3 is turned upside down and is placed on a perforated plate 12 disposed on a conveyor 11 of an induction drying device (second induction drying device) 20, and voltage is applied to electrode plates 15, 16 located above and below the first dried honeycomb formed body 3. Then, the honeycomb formed body is dried using high-frequency energy. In this way, the first dried honeycomb formed body 3 is induction-dried to obtain a honeycomb dried body (second drying step).

In the induction drying step of the present invention, the method for turning the first dried honeycomb formed body 3 upside down is not limited especially. For instance, as shown in FIG. 1, two induction drying devices (the first induction drying device 10 and the second induction drying device 20) may be prepared, and a robot arm may be disposed between these devices. More specifically, lateral faces of the first dried honeycomb formed body discharged from the first induction drying device are grasped with the robot arm to turn the first dried honeycomb formed body upside down, and then is supplied to the second induction drying device. It should be noted that the process is preferably controlled beforehand so that when the non-fired honeycomb formed body is discharged from the first induction drying device 10, 10 to 50% of the entire water that the non-fired honeycomb fowled body contained before the drying has been removed. Instead of the robot arm, a human operator may perform the above operation.

In this way, the induction drying step may be performed using a plurality of induction drying devices. This method of the present invention can be performed easily because a conventional induction drying device can be used as it is.

Instead of using a plurality of induction drying devices as stated above, one induction drying device may be used. In this case, means to turn a non-fired honeycomb formed body upside down (turning means) may be disposed in the induction drying device.

(1-1) Step of Manufacturing a Honeycomb Formed Body:

In the step of manufacturing a honeycomb formed body, “a non-fired honeycomb formed body including a cell wall that defines a plurality of cells extending from a first end face as one end face to a second end face as the other end face” is manufactured by forming a raw material composition containing a ceramic raw material and water as stated above. Herein the non-fired honeycomb formed body refers to a honeycomb formed body in the state where particles of the ceramic raw material are present while keeping the particulate shape when the raw material composition is formed into a honeycomb shape and the ceramic raw material is not sintered.

The ceramic raw material contained in the raw material composition preferably includes at least one type of materials selected from the group consisting of cordierite forming raw material, cordierite, silicon carbide, silicon-silicon carbide composite material, mullite, and aluminum titanate. The cordierite forming raw material is a ceramic raw material formulated to have a chemical composition in the range of 42 to 56 mass % of silica, 30 to 45 mass % of alumina and 12 to 16 mass % of magnesia. The cordierite forming raw material forms cordierite after firing.

The raw material composition may be prepared by mixing the ceramic raw material and water as stated above with dispersing medium, organic binder, inorganic binder, pore former, surfactant and the like. The composition ratio of these raw materials is not limited especially, and any composition ratio suitable for the structure of the honeycomb structure to be manufactured, its materials and the like is preferable.

The pore former is not limited especially, and can be selected as needed. For instance, the examples of the pore former include water absorbable resin, silica gel and coke. The “water absorbable resin” refers to resin having a property of swelling to a few to dozens of times its volume when the resin absorbs water. The example of such resin includes sodium polyacrylate.

In the present invention, the additive amount of the pore former is less than 0.5 mass % in the raw material composition. In the present invention, pore former may not be added, i.e., 0 mass % in the raw material composition.

When the raw material composition is formed, the raw material composition is firstly kneaded to be a kneaded material, and the obtained kneaded material is formed to have a honeycomb shape having a plurality of through holes so as to make a honeycomb formed body. A method for preparing the kneaded material by kneading the raw material composition may be a method using a kneader or a vacuum pugmill, for example. A method for forming the kneaded material to make a honeycomb formed body may be a known forming method, such as extrusion and injection molding. More specifically, a honeycomb formed body is preferably made by extrusion using a die having a desired cell shape, partition wall (cell wall) thickness and cell density. A preferable material of the die is cemented carbide having wear resistance.

The shape of cells of the non-fired honeycomb formed body (the shape of cells in a cross section orthogonal to the extending direction of the cells) is not limited especially. Examples of the shape of cells include a triangle, a quadrangle, a hexagon, an octagon, a circle and the combination of them.

The shape of the honeycomb formed body is not limited especially, and the examples of the shape include a round pillar shape, an elliptic pillar shape, and a polygonal prismatic columnar shape having an end face of a shape, such as “square, rectangle, triangle, pentagon, hexagon, and octagon”.

When the honeycomb formed body has a round pillar shape, the non-fired honeycomb formed body may have a diameter at the end face of 50 to 400 mm, preferably 80 to 400 mm, and more preferably 80 to 350 mm.

The non-fired honeycomb formed body may have a length in the cell-extending direction of 100 to 400 mm, preferably 150 to 400 mm, and more preferably 150 to 350 mm.

The honeycomb formed body may have a thickness of the cell wall of 30 to 350 μm. That is, the non-fired honeycomb formed body to be supplied to the induction drying step may have a thickness of the cell wall of 50 to 350 μm. Preferably the honeycomb formed body may have a thickness of the cell wall of 30 to 300 μm, and more preferably 30 to 200 When a honeycomb formed body has a thickness of the cell wall in the above range, a breakage easily occurs at the partition wall during drying in the conventional method. On the contrary, the present invention can suppress such a breakage at a thin partition wall as well, as described above. Note here that a breakage occurs at the non-fired honeycomb formed body during drying due to non-uniform distribution of water in the non-fired honeycomb formed body and so a difference in contraction generated in the non-fired honeycomb formed body. Especially such a difference in contraction greatly affects a thin cell wall, and therefore a breakage easily occurs at the cell wall. According to the present invention, a non-fired honeycomb formed body is turned upside down under a predetermined condition during the induction drying step, whereby a difference in contraction during drying can be suppressed.

The content of water in a non-fired honeycomb formed body may vary with the characteristics required for the product. A non-fired honeycomb formed body covered by the present invention preferably has water content in the range of 20 to 50%. That is, the non-fired honeycomb formed body to be supplied to the induction drying step preferably has the water content before drying of 20 to 50%. Preferably the water content of this non-fired honeycomb formed body is in the range of 20 to 40%, and particularly preferably 20 to 30%. The water content of the “non-fired honeycomb formed body” is a value obtained by measuring the raw material composition with an infrared heating moisture meter.

(1-2) Induction Drying Step:

The induction drying step is to dry the manufactured non-fired honeycomb formed body by induction drying so as to obtain a honeycomb dried body. This induction drying step includes a first drying step, a subsequent step of turning upside down, and a second drying step. In this way, the present invention includes the step of turning the first dried honeycomb formed body upside down between the first drying step and the second drying step. Such an induction drying step including these steps has short drying time of the honeycomb formed body and as a result, the manufacturing time of the honeycomb structure can be shortened.

The induction drying method is to apply electric current between electrodes disposed above and below the honeycomb formed body so as to generate high-frequency energy there and dry the honeycomb formed body by the high-frequency energy. The induction drying is performed using an induction drying device including one electrode (upper electrode) located above the non-fired honeycomb formed body and the other electrode (lower electrode) located below the non-fired honeycomb formed body. This induction drying device is configured so that “distance D1” between the upper end face of the non-fired honeycomb formed body and the upper electrode and “distance D2” between the lower end face of the non-fired honeycomb formed body and the lower electrode are different, and the distance D1 is longer than the distance D2. Such a distance between the upper end face (first end face) of the non-fired honeycomb formed body and the upper electrode is called an air gap. This air gap allows the water at an upper part of the non-fired honeycomb formed body to remain more than the water at a lower part. As a result, water is distributed non-uniformly in such a non-fired honeycomb formed body. Such non-uniform distribution of water greatly degrades the efficiency of drying by the induction drying device, and so the drying does not progress well. To progress the drying, another drying step, such as microwave drying, after the induction drying is added, or the time of the induction drying is lengthened. It is difficult to correct such non-uniform distribution of water using an auxiliary electrode.

When another drying processing, such as microwave drying, is performed in addition to the induction drying, a device for the drying and a space to place the device are required, and so the manpower and cost increases. When the time of induction drying is lengthened, the time to manufacture the honeycomb structure is greatly lengthened and electrical power is required a lot, and so the cost increases. Then, there is a demand for a method of substantially finishing the drying of a non-fired honeycomb formed body by induction drying.

According to the present invention, a non-fired honeycomb formed body can be almost dried by induction drying, and so the drying time is short.

(1-2-1) First Drying Step:

In this step, “a first dried honeycomb formed body” is obtained by removing “10 to 50% of the entire water that the non-fired honeycomb formed body contained before drying”. That is, this step ends when 10 to 50% of the entire water that the non-fired honeycomb formed body contained before drying is removed, and then the procedure shifts to the second drying step.

The water content of the first dried honeycomb formed body is obtained by measuring the mass of the non-fired honeycomb formed body before drying and the mass of the honeycomb formed body after induction drying (first dried honeycomb formed body) to find the amount of removed water, and calculating the water content based on the removed amount of water. Induction drying may be performed beforehand under a plurality of drying conditions so as to find a condition achieving the water content of the first dried honeycomb formed body in the range as stated above.

In the first drying step of the present invention, 10 to 50% of the entire water that the non-fired honeycomb formed body contained before drying is removed. Preferably 20 to 40% of the entire water that the non-fired honeycomb formed body contained before drying is removed. If this step ends when less than 10% of the entire water that the non-fired honeycomb formed body contained before drying is removed, a difference in contraction is generated between a non-dried part (a part where the drying is not sufficient) and another part during the following step (hot air drying step and firing step), and so a breakage may occur at the cell wall (partition wall). When the cell wall is thin (specifically 78 μm or less), such a breakage occurs often. If this step ends when 50% and above of the entire water that the non-fired honeycomb formed body contained before drying is removed, the honeycomb formed body has large electrical resistance, and so the output cannot be increased enough. Therefore the efficiency of the drying processing deteriorates. This leads to an increase in voltage between the electrodes, and so the load applied to the induction drying device increases, which leads to an increase of the risk of discharging. In this case, malfunction of the device may occur frequently due to the discharging.

(1-2-2) Turning Upside Down Step:

This step is to turn the first dried honeycomb formed body upside down. Since the present invention includes such a turning upside down step, the water in the honeycomb formed body can be made uniform as the induction drying progresses. Therefore the present invention can suppress a breakage of the honeycomb formed body, and can shorten the induction time. As a result of such short induction time, the time to manufacture the honeycomb structure can be shortened.

“Turning the first dried honeycomb formed body upside down” refers to inversion of one end face and the other end face in position of the first dried honeycomb formed body. That is, as shown in FIG. 1, the pillar-shaped first dried honeycomb formed body having one end face and the other end face is typically disposed with the one end face (first end face) upward and the other end face (second end face) downward for induction drying. Then, the operation to invert these first end face and second end face in position is called “turning upside down”.

(1-2-3) Second Drying Step:

This step is to remove the residual water by additional induction drying to obtain a honeycomb dried body. The condition of induction drying in this step may be similar to that in the induction drying step in the first drying step. Alternatively, a condition different from the induction drying step in the first drying step may be used.

After this step, 90% or more of the entire amount of water content of the non-fired honeycomb formed body is preferably removed. This can suppress a “breakage” also in the following step (hot air drying step or firing step).

In the induction drying step (first drying step and second drying step), a conventionally known condition may be used as needed for the frequency and the output. For instance, the frequency may be 10 to 50 MHz. The output may be 5 to 200 kW.

Preferably the induction drying step is performed while keeping the temperature at a center part of each of the non-fired honeycomb formed body and the first dried honeycomb formed body at 150° C. or lower. This can avoid deformation of the non-fired honeycomb formed body and the first dried honeycomb formed body. If the temperature of the non-fired honeycomb formed body exceeds 150° C., organic auxiliary agent, which is mixed to improve the shape-retainability of the non-fired honeycomb formed body, reaches its combustion temperature range, and so the strength of the honeycomb formed body after drying is not enough and the first dried honeycomb formed body may collapse.

The temperature of a center part of the non-fired honeycomb fowled body and the first dried honeycomb formed body may be measured by embedding a compact temperature-measuring device in a product (non-fired honeycomb formed body before drying) in a preliminary test. Preferably a condition that can keep the temperature of a center part of the non-fired honeycomb formed body and the first dried honeycomb formed body at 150° C. or less is found beforehand.

(1-2-4) Hot Air Drying Step:

The present invention may further include a hot air drying step to dry the honeycomb dried body subjected to the induction drying step by hot air.

Such a hot air drying step can further dry the honeycomb dried body. The induction drying step of the present invention can prevent the flow path of hot air during the hot air drying step from being transferred to the honeycomb dried body. That is, this can prevent burning of the end face on one side of the honeycomb dried body due to hot air. In this way, the induction drying step of the present invention can lead to favorable drying processing also in the following hot air drying step.

For this hot air drying step, a conventionally known method may be used as needed.

(1-3) Firing Step:

In the firing step, the honeycomb dried body subjected to the induction drying step is fired to obtain a honeycomb structure.

The honeycomb dried body may be fired in a firing oven, for example. For the firing oven and the firing condition, a conventionally known condition may be selected as needed to be suitable for the shape, the material and the like of the honeycomb dried body. The honeycomb dried body may be calcinated before the firing to burn and remove organic substances, such as binder.

### EXAMPLES

The following describes the present invention more specifically by way of examples. The present invention is not limited to the following examples.

### Example 1

Binder including organic binder, pore former (the additive amount was less than 0.5% of the raw material composition (kneaded material)), and water (32 mass %) as the dispersing medium were firstly mixed with the cordierite forming raw material including the mixture of alumina, kaolin and talc as the ceramic raw material. This was kneaded to obtain a kneaded material (step of manufacturing a honeycomb formed body).

The obtained kneaded material was extruded so as to obtain a non-fired honeycomb formed body having cells of a square in cross section orthogonal to the cell-extending direction. This non-fired honeycomb formed body had a diameter of 144 mm, a length (length in the cell-extending direction) of 200 mm, and this honeycomb formed body had externally a round pillar shape.

The obtained non-fired honeycomb formed body had the water content of 23% (in Table 1, described as “initial water content”), the cell density of 62 pieces/cm², the thickness of cell wall of 100 μm, and the mass (mass before drying) of 1326 g. This non-fired honeycomb formed body was dried as follows.

The obtained non-fired honeycomb formed body was induction-dried using an inducting drying device. Specifically, the non-fired honeycomb formed body was induction-dried (dried by the first induction drying device (first drying step)) as a batch with the frequency of 40 MHz, the output of 4 kW and the heating time of 120 seconds. In this way, a first dried honeycomb formed body (having mass (mass before turning upside down) of 1186 g) was obtained by removing 45.9% of the entire water that the non-fired honeycomb formed body contained before drying. The water content of the first dried honeycomb formed body was 12.4%. Under the above-stated drying condition, the temperature of the center part of the non-fired honeycomb formed body was 98° C. (150° C. or lower). This temperature of the non-fired honeycomb formed body was measured with an optical fiber thermometer.

In Table 2 and Table 5, “first removal ratio (%)” indicates the ratio (%) of the water amount removed at the first drying step relative to the mass before drying. More specifically this is the value calculated in accordance with the expression: {1−(mass before turning upside down/mass before drying)}×100. “First drying ratio (%)” indicates the ratio (%) of the water amount removed at the first drying step relative to the water content of the non-fired honeycomb fowled body. More specifically this is the value calculated in accordance with the expression: (mass before drying-mass before turning upside down)/(mass before drying x initial water content)×100. This “first drying ratio (%)” indicates the amount of water removed from the entire water amount that the non-fired honeycomb formed body contained before drying. That is, it is necessary for the present invention that this first drying ratio (%) is 10 to 50%.

Next, induction drying was further performed using the above-mentioned induction drying device. At this time, the first dried honeycomb formed body was turned upside down and then was placed at the induction drying device. The drying was performed under a similar condition to the above. Specifically, the drying was performed with the frequency of 40 MHz, the output of 4 kW and the heating time of 140 seconds. In this way, the residual water was removed so as to obtain a honeycomb dried body (dried by a second induction drying device (second drying step)). The temperature of the center part of the first dried honeycomb formed body was 120° C. (150° C. or less).

Next, the water content of the honeycomb dried body was measured to confirm that the honeycomb dried body was dried. The result showed that the water content of the honeycomb dried body was 1.1% (see Table 2). The honeycomb dried body had mass (final mass) of 1035 g. In Table 2 and Table 5, “final removal ratio (%)” indicates the ratio (%) of the total removed water amount relative to the mass before drying in the induction drying step (first drying step and second drying step). “Final drying ratio (%)” indicates the ratio (%) of the total removed water amount in the induction drying step (first drying step and second drying step) relative to the amount of water contained in the non-fired honeycomb formed body.

As shown in Table 3, the honeycomb dried body obtained in this Example had a locally remaining moisture percentage at the upper part (one end part) of 4.6% and a locally remaining moisture percentage at the lower part (the other end part) of 1.4%. A difference between them (upper part-lower part) was 3.2%. In this measurement of the locally remaining moisture percentage, the “upper part” means a position of 20 mm in depth from the one end face (end face located above in the first drying step) of the honeycomb dried body. In the measurement of the locally remaining moisture percentage, the “lower part” means a position of 20 mm in depth from the other end face (end face located below in the first drying step) of the honeycomb dried body.

The locally remaining moisture percentage was measured using a soil moisture sensor (produced by DECAGON, probe EC-5 (product name)) by the electric capacitance method. The locally remaining moisture percentage was measured by inserting the soil moisture sensor into the measurement target (non-fired honeycomb formed body) by 60 mm from the lateral face at the depth (20 mm) from the end face of the measurement target (non-fired honeycomb formed body).

(The Number of Generated Breakages During Drying)

In the method of the present example, fifteen honeycomb dried bodies were selected randomly from the obtained honeycomb dried bodies, and the appearance of them was visually examined about the presence or not of a breakage of the honeycomb formed body (i.e., about the presence of a breakage of the honeycomb formed body). One of the fifteen honeycomb dried body had a breakage.

These honeycomb dried bodies were fired to obtain honeycomb structures. A breakage occurred at one of the fifteen honeycomb structures (the number of the honeycomb structures having a breakage)). Table 3 and Table 6 show the result. Firing was performed at 1400° C. for 5 hours.

(Total Drying Time (sec.))

The drying time in the induction drying step was measured for each of the honeycomb dried bodies manufactured. Table 3 and Table 6 show the result in the fields of “total drying time (sec.))”.

TABLE 1

| | Non-fired honeycomb formed body | | | | | | |
|---|---|---|---|---|---|---|---|
| | | Diameter | Length | Cell wall | Cell density | Mass before | Initial water |
| | Outer shape | (mm) | (mm) | thickness (μm) | (pieces/cm²) | drying (g) | content (%) |
| Comp. Ex. 1 | round-pillar shape | 144 | 200 | 100 | 62 | 1345 | 23 |
| Comp. Ex. 2 | round-pillar shape | 144 | 200 | 100 | 62 | 1318 | 23 |
| Ex. 1 | round-pillar shape | 144 | 200 | 100 | 62 | 1326 | 23 |
| Ex. 2 | round-pillar shape | 144 | 200 | 100 | 62 | 1339 | 23 |
| Ex. 3 | round-pillar shape | 144 | 200 | 100 | 62 | 1330 | 23 |
| Ex. 4 | round-pillar shape | 144 | 200 | 100 | 62 | 1310 | 23 |
| Comp. Ex. 3 | round-pillar shape | 144 | 200 | 100 | 62 | 1317 | 23 |
| Comp. Ex. 4 | round-pillar shape | 144 | 200 | 100 | 62 | 1314 | 23 |

TABLE 2

| | | | | | First dried honeycomb formed body | | | |
|---|---|---|---|---|---|---|---|---|
| | First drying step | | | | Mass | Water | First | First |
| | Frequency | Output | Time | Temperature at | before | content | removal | drying |
| | (MHz) | (kW) | (sec.) | center part (° C.) | turning (g) | (%) | ratio (%) | ratio (%) |
| Comp. Ex. 1 | 40 | 4 | 300 | 118 | — | 1.1 | 21.9 | 95.2 |
| Comp. Ex. 2 | 40 | 4 | 180 | 112 | 1107 | 7.0 | 16.0 | 69.6 |
| Ex. 1 | 40 | 4 | 120 | 98 | 1186 | 12.4 | 10.6 | 45.9 |
| Ex. 2 | 40 | 4 | 100 | 92 | 1213 | 13.6 | 9.4 | 40.9 |
| Ex. 3 | 40 | 4 | 60 | 83 | 1256 | 17.4 | 5.6 | 24.2 |
| Ex. 4 | 40 | 4 | 30 | 76 | 1272 | 20.1 | 2.9 | 12.6 |
| Comp. Ex. 3 | 40 | 4 | 20 | 64 | 1298 | 21.6 | 1.4 | 6.3 |
| Comp. Ex. 4 | 40 | 4 | 10 | 32 | 1304 | 22.2 | 0.8 | 3.3 |

| | | | | | Honeycomb dried body | | | |
|---|---|---|---|---|---|---|---|---|
| | Second drying step | | | | Final | Water | Final | Final |
| | Frequency | Output | Time | Temperature at | mass | content | removal | drying |
| | (MHz) | (kW) | (sec.) | center part (° C.) | (g) | (%) | ratio (%) | ratio (%) |
| Comp. Ex. 1 | — | — | — | — | 1051 | 1.1 | 21.9 | 95.0 |
| Comp. Ex. 2 | 40 | 4 | 120 | 122 | 1027 | 0.9 | 22.1 | 96.1 |
| Ex. 1 | 40 | 4 | 140 | 120 | 1035 | 1.1 | 21.9 | 95.4 |
| Ex. 2 | 40 | 4 | 150 | 117 | 1043 | 0.9 | 22.1 | 96.1 |
| Ex. 3 | 40 | 4 | 200 | 114 | 1041 | 1.3 | 21.7 | 94.5 |
| Ex. 4 | 40 | 4 | 220 | 115 | 1027 | 1.4 | 21.6 | 93.9 |
| Comp. Ex. 3 | 40 | 4 | 290 | 124 | 1028 | 1.1 | 21.9 | 95.4 |
| Comp. Ex. 4 | 40 | 4 | 300 | 121 | 1026 | 1.1 | 21.9 | 95.3 |

TABLE 3

| | Locally remaining | | | | The | |
|---|---|---|---|---|---|---|
| | moisture | | | The | number of | |
| | percentage (%) | | | number of | breakages | Total |
| | | | Difference | breakages | of honey- | drying |
| | Upper | Lower | (upper − | during | comb | time |
| | part | part | lower) | drying | structures | (sec.) |
| Comp. | 6.2 | 0.3 | 5.9 | 15 | 15 | 300 |
| Ex. 1 | | | | | | |
| Comp. | 5.4 | 0.3 | 5.1 | 3 | 4 | 300 |
| Ex. 2 | | | | | | |
| Ex. 1 | 4.6 | 1.4 | 3.2 | 1 | 1 | 260 |
| Ex. 2 | 3.5 | 1.7 | 1.8 | 1 | 1 | 250 |
| Ex. 3 | 1.7 | 2.8 | −1.1 | 0 | 0 | 260 |
| Ex. 4 | 1.0 | 3.6 | −2.6 | 1 | 1 | 250 |
| Comp. | 0.1 | 4.7 | −4.6 | 1 | 2 | 310 |
| Ex. 3 | | | | | | |
| Comp. | 0.8 | 5.8 | −5.0 | 8 | 10 | 310 |
| Ex. 4 | | | | | | |

### Examples 2 to 5, Comparative Examples 1 to 6

Honeycomb structures were manufactured similarly to Example 1 except that the conditions were changed as in Table 1, Table 2, Table 4 and Table 5. Table 3 and Table 6 show the evaluation result of the honeycomb dried bodies and the honeycomb structures in this method.

TABLE 4

| | Non-fired honeycomb formed body | | | | | | |
|---|---|---|---|---|---|---|---|
| | | Diameter | Length | Cell wall | Cell density | Mass before | Initial water |
| | Outer shape | (mm) | (mm) | thickness (μm) | (pieces/cm²) | drying (g) | content (%) |
| Comp. Ex. 5 | Round pillar shape | 120 | 230 | 75 | 90 | 1151 | 24 |
| Comp. Ex. 6 | Round pillar shape | 120 | 230 | 75 | 90 | 1147 | 24 |
| Ex. 5 | Round pillar shape | 120 | 230 | 75 | 90 | 1153 | 24 |

TABLE 5

| | | | | | First dried honeycomb formed body | | | |
|---|---|---|---|---|---|---|---|---|
| | First drying step | | | | Mass | Water | First | First |
| | Frequency | Output | Time | Temperature at | before | content | removal | drying |
| | (MHz) | (kW) | (sec.) | center part (° C.) | turning (g) | (%) | ratio (%) | ratio (%) |
| Comp. Ex. 5 | 40 | 2 | 630 | 125 | 878 | 0.3 | 23.7 | 98.8 |
| Comp. Ex. 6 | 40 | 2 | 360 | 102 | 995 | 10.7 | 13.3 | 55.2 |
| Ex. 5 | 40 | 2 | 180 | 98 | 1082 | 17.8 | 6.2 | 25.7 |

| | | | | | Honeycomb dried body | | | |
|---|---|---|---|---|---|---|---|---|
| | Second drying step | | | | Final | Water | Final | Final |
| | Frequency | Output | Time | Temperature at | mass | content | removal | drying |
| | (MHz) | (kW) | (sec.) | center part (° C.) | (g) | (%) | ratio (%) | ratio (%) |
| Comp. Ex. 5 | — | — | — | — | 878 | 0.3 | 23.7 | 98.8 |
| Comp. Ex. 6 | 40 | 2 | 250 | 120 | 874 | 0.2 | 23.8 | 99.2 |
| Ex. 5 | 40 | 2 | 370 | 122 | 892 | 1.4 | 22.6 | 94.3 |

TABLE 6

| | Locally remaining | | | | The | |
|---|---|---|---|---|---|---|
| | moisture | | | The | number of | |
| | percentage (%) | | | number of | breakages | Total |
| | | | Difference | breakages | of honey- | drying |
| | Upper | Lower | (upper − | during | comb | time |
| | part | part | lower) | drying | structures | (sec.) |
| Comp. | 3.7 | 0.4 | 3.3 | 5 | 8 | 630 |
| Ex. 5 | | | | | | |
| Comp. | 3.2 | 0.6 | 2.6 | 3 | 3 | 610 |
| Ex. 6 | | | | | | |
| Ex. 5 | 3.3 | 3.8 | −0.5 | 0 | 1 | 550 |

Table 3 and Table 6 show that the method for manufacturing a honeycomb structure according to Examples 1 to 5 had short drying time of a honeycomb formed body as compared with the method for manufacturing a honeycomb structure of Comparative Examples 1 to 6 and as a result, the manufacturing time of the honeycomb structure had been shortened.

A method for manufacturing a honeycomb structure of the present invention can be used to manufacture a honeycomb structure available as a filter to purify exhaust gas from automobiles or the like.

### DESCRIPTION OF REFERENCE NUMERALS

1: Non-fired honeycomb formed body, 3: First dried honeycomb formed body, 10: First induction drying device, 11: Conveyor, 12: Perforated plate, 15, 16: Electrode plates, 20: Second induction drying device

What is claimed is:

1. A method for manufacturing a honeycomb structure, comprising:
a step of manufacturing a honeycomb formed body to manufacture a non-fired honeycomb formed body including a cell wall that defines a plurality of cells extending from a first end face as one end face to a second end face as the other end face, the non-fired honeycomb formed body including a raw material composition containing a ceramic raw material and water;
an induction drying step of drying the manufactured non-fired honeycomb formed body by induction drying to obtain a honeycomb dried body; and
a firing step of firing the obtained honeycomb dried body to obtain a honeycomb structure, wherein
the induction drying step is to remove 10 to 50% of the entire water that the non-fired honeycomb formed body contained before drying by induction drying to obtain a first dried honeycomb formed body, then turn the first dried honeycomb formed body upside down and remove the residual water by further induction drying to obtain the honeycomb dried body.

2. The method for manufacturing a honeycomb structure according to claim 1, wherein the non-fired honeycomb formed body to be supplied to the induction drying step has water content before drying of 20 to 50%.

3. The method for manufacturing a honeycomb structure according to claim 1, further comprising a hot air drying step of further drying the honeycomb dried body subjected to the induction drying step by hot air.

4. The method for manufacturing a honeycomb structure according to claim 1, wherein the non-fired honeycomb formed body to be supplied to the induction drying step has a thickness of the cell wall that is 50 to 350 μm.

5. The method for manufacturing a honeycomb structure according to claim 1, wherein, in the induction drying step, drying is performed using a first induction drying device to obtain the first dried honeycomb formed body and a second induction drying device to further induction-dry the first dried honeycomb formed body to obtain the honeycomb dried body.
